(19) United States
(12) Patent Application Publication
(10) Pub. No.: US 2012/0048455 A1
(43) Pub. Date: Mar. 1, 2012

(54) THERMOPLASTIC PIPE MADE WITH COMMINGLED GLASS FIBERS

(75) Inventors: Gilles Rocher, La Croix Sur Lutry (CH); Claude Renaud, Herve (BE); Philippe Boissonnat, Challes Les Eaux (FR)

(73) Assignee: OCV INTELLECTUAL CAPITAL, LLC, Toledo, OH (US)

(21) Appl. No.: 13/318,164

(22) PCT Filed: Jun. 23, 2009
(86) PCT No.: PCT/IB09/06326

§ 371 Date: Oct. 31, 2011

(51) Int. Cl. B29C 53/56; B32B 38/00; B32B 37/14

(52) U.S. Cl. 156/190; 156/250

(57) ABSTRACT

Methods of manufacturing a continuous pipe from thermoplastic materials are provided. The methods include the steps of providing an endless mandrel having a releasable surface, the endless mandrel configured for rotation, forming an inner liner layer on the releasable surface of the endless mandrel, forming an intermediate layer on the inner liner layer, forming an outer layer on the intermediate layer, thereby forming a continuous pipe and cutting the continuous pipe into segments. The method is characterized in that the inner liner layer is made of a thermoplastic material, the intermediate layer is made of commingled thermoplastic material and glass fiber reinforcement material, and the outer layer is made of a thermoplastic material.

### BACKGROUND

Pipes are used in many different applications, such as for example transporting gasses and fluids and protecting cables. The applications for pipes can result in diverse pipe sizes and technical requirements. Factors, such as for example pressure, corrosion resistance and drinking water compatibility result in pipes manufactured from varying materials. Examples of pipe materials include steel, cast iron, concrete, glass reinforced plastics and plastic. Plastic pipes are generally manufactured from thermoset resins and thermoplastic resins.

Pipes made of thermoset resins can be reinforced by glass fibres. Thermoset resins for pipes can be unsaturated polyester or vinylester or epoxy. These resins can be brittle, and are customarily reinforced by glass fibres. Typically, these resins have a low viscosity before polymerization. The low viscosity of the resins provides a good impregnation of the glass fibers, and a good quality and mechanical behavior of the final thermoset composite pipe.

Examples of thermoplastic resins include polyvinyl chloride (PVC), high density polyethylene (HDPE) and polypropylene (PP). In some instances, thermoplastic resins can be too viscous to ensure good impregnation of glass fibres and the mechanical properties of thermoplastic pipes can be below those of other pipe materials, such as for example steel and concrete. Thermoplastic pipes can be used in applications where the internal pipe pressure is low and the pipe diameter less than about 300 mm. Use of thermoplastic pipe in diameters larger than about 300 mm can result in larger wall thicknesses, high cost and low manufacturing productivity. However, pipes made of thermoplastic resins can have good chemical and corrosion resistance, excellent drinking water compatibility and can be easily connected by processes such as welding. It would be advantageous to provide pipes made of thermoplastic resins having pipe diameters larger than 300 mm. It would also be advantageous to provide pipe made of thermoplastic resins having improved mechanical resistance.

### SUMMARY

In accordance with embodiments of this invention there are provided apparatus and methods of manufacturing a continuous pipe from thermoplastic materials. The methods include the steps of providing an endless mandrel having a releasable surface, the endless mandrel configured for rotation, forming an inner liner layer on the releasable surface of the endless mandrel, forming an intermediate layer on the inner liner layer, forming an outer layer on the intermediate layer, thereby forming a continuous pipe and cutting the continuous pipe into segments. The method is characterized in that the inner liner layer is made of a thermoplastic material, the intermediate layer is made of commingled thermoplastic material and glass fiber reinforcement material, and the outer layer is made of a thermoplastic material.

Various advantages of this invention will become apparent to those skilled in the art from the following detailed description of the invention, when read in light of the accompanying drawings.

### BRIEF DESCRIPTION OF THE DRAWINGS

FIG. 1 is a side view in elevation of a first embodiment of an apparatus for manufacturing thermoplastic pipe.

FIG. 2 is a cross-sectional view of a first embodiment of a pipe manufacturing by the apparatus of FIG. 1.

FIG. 3 is a cross-sectional view of a second embodiment of a pipe.

FIG. 4 is a side view in elevation of a second embodiment of an apparatus for manufacturing thermoplastic pipe.

FIG. 5 is a perspective view of a second embodiment of a composite ribbon for use in manufacturing thermoplastic pipe.

FIG. 6 is a cross-sectional view of a third embodiment of a composite ribbon for use in manufacturing thermoplastic pipe.

FIG. 7 is a side view in elevation of a third embodiment of an apparatus for manufacturing thermoplastic pipe.

FIG. 8 is a cross-sectional view of a portion of a manufactured thermoplastic pipe illustrating overlapping composite ribbons.

FIG. 9 is a perspective view of a bell housing for use in connecting thermoplastic pipe.

FIG. 10 is a side view in elevation of an apparatus for manufacturing the bell housing of FIG. 9 illustrating attachment of a bell housing form.

FIG. 11 is a side view in elevation of apparatus similar to that shown in FIG. 7, illustrating an installed bell housing form.

### DETAILED DESCRIPTION OF THE INVENTION

The present invention will now be described with occasional reference to the specific embodiments of the invention. This invention may, however, be embodied in different forms and should not be construed as limited to the embodiments set forth herein. Rather, these embodiments are provided so that this disclosure will be thorough and complete, and will fully convey the scope of the invention to those skilled in the art.

Unless otherwise defined, all technical and scientific terms used herein have the same meaning as commonly understood by one of ordinary skill in the art to which this invention belongs. The terminology used in the description of the invention herein is for describing particular embodiments only and is not intended to be limiting of the invention. As used in the description of the invention and the appended claims, the singular forms “a,” “an,” and “the” are intended to include the plural forms as well, unless the context clearly indicates otherwise.

Unless otherwise indicated, all numbers expressing quantities of dimensions such as length, width, height, and so forth as used in the specification and claims are to be understood as being modified in all instances by the term “about.” Accordingly, unless otherwise indicated, the numerical properties set forth in the specification and claims are approximations that may vary depending on the desired properties sought to be obtained in embodiments of the present invention. Notwithstanding that the numerical ranges and parameters setting forth the broad scope of the invention are approximations, the numerical values set forth in the specific examples are reported as precisely as possible. Any numerical values, however, inherently contain certain errors necessarily resulting from error found in their respective measurements.

In accordance with embodiments of the present invention, continuous thermoplastic pipe made from commingled fibers and methods of making same are provided. The term “pipe” as used herein, is defined to mean a hollow structure configured to convey materials or for use as a structural member. The term “thermoset”, as used herein, is defined to mean materials that irreversibly cure. The term “thermoplastic”, as used herein, is defined to mean materials that substantially “melt” at certain temperatures thereby forming a soft, flexible and elastic material, and freeze below the certain temperatures.

The description and figures disclose apparatus and methods for manufacturing continuous thermoplastic pipe. Generally, the disclosed and illustrated thermoplastic pipe has a relatively small wall thickness and a minimum outer diameter of approximately 300 mm. The thermoplastic pipe can be provided in various outer diameter sizes and is suitable for a variety of uses including as a conduit for drinking water.

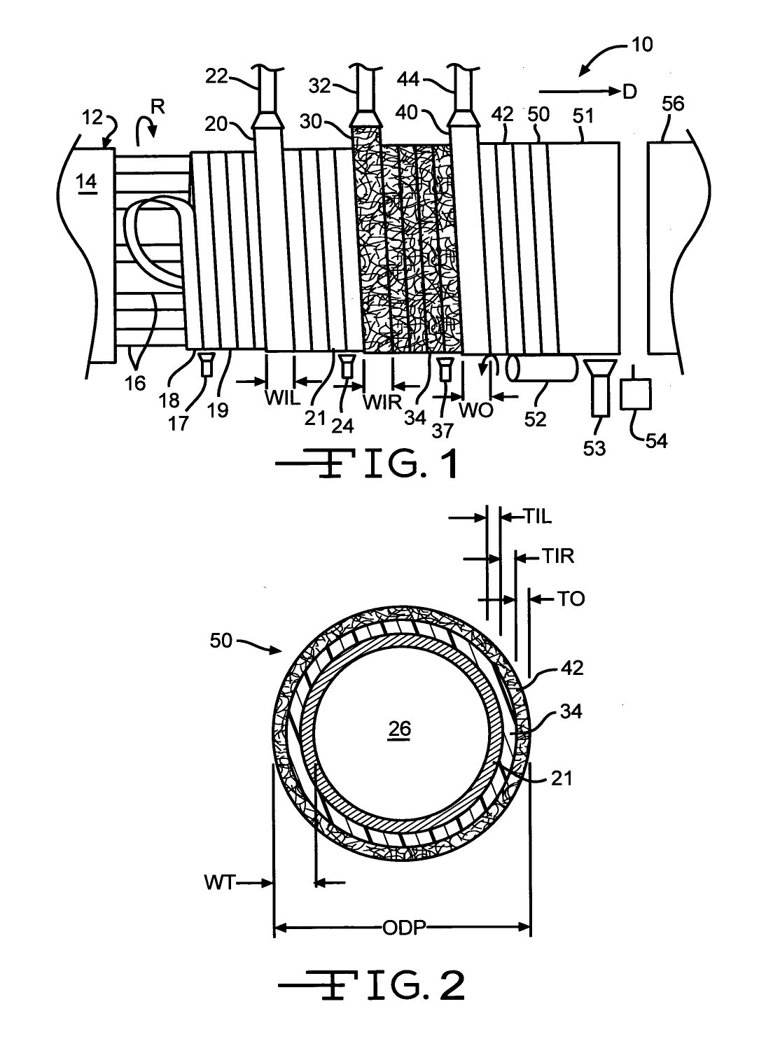

Referring now to FIG. 1, an apparatus for manufacturing continuous thermoplastic pipe is illustrated at 10. Generally, the apparatus 10 manufactures a continuous thermoplastic pipe having a plurality of layers. The continuous thermoplastic pipe moves in machine direction D and is cut into segments in downstream operations. The apparatus includes a mandrel 12 configured for rotation in direction R. The mandrel 12 can be rotated by any desired mechanisms, devices or apparatus. In the illustrated embodiment, the mandrel 12 has a rotational speed in a range of from about 0.5 revolutions/minute to about 50 revolutions/minute. However, the mandrel 12 can have a rotational speed less than about 0.5 revolutions/minute or more than about 50 revolutions/minute.

The mandrel 12 includes a face plate 14, a plurality of rods 16 and tape 18. The face plate 14 is configured for retention of the rods 16 in a spaced apart orientation. In the illustrated embodiment, the face plate 14 is made of a metallic material and has a circular cross-sectional shape. Alternatively, the face plate 14 can be made of other desired materials and can have other desired cross-sectional shapes.

Referring again to FIG. 1, the rods 16 are connected to and extend from the face plate 14. The rods 16 are spaced apart about the face plate 14 in a manner such as form a substantially circular outer perimeter. The substantially circular outer perimeter of the rods 16, covered by the tape 18, is configured to provide a form about which various layers forming a continuous pipe can be applied. The rods 16 can have any cross-sectional shape, such as for example a circular cross-sectional shape, sufficient to form a substantially circular outer perimeter. The rods 16 can have any desired diameter and can be made of any desired materials.

The outer perimeter of the rods 16 is covered by a tape 18. The tape 18 is configured to form a tape layer 19 having releasable surface upon which various subsequent layers forming a continuous pipe can be applied. In the illustrated embodiment, the tape 18 is made of a metallic material, such as for example steel. However, the tape 18 can be made of other desired materials. The tape 18 can have any desired thickness and width, and can be applied to the rods 16 in any desired manner sufficient to form a tape layer 19 having a releasable surface.

Optionally, a first cooling mechanism 17 can be configured to cool the tape layer 19. The first cooling mechanism 17 can be configured to cool the tape layer 19 to any desired temperature. The first cooling mechanism 17 can be any desired structure, mechanism or device, such as a blower.

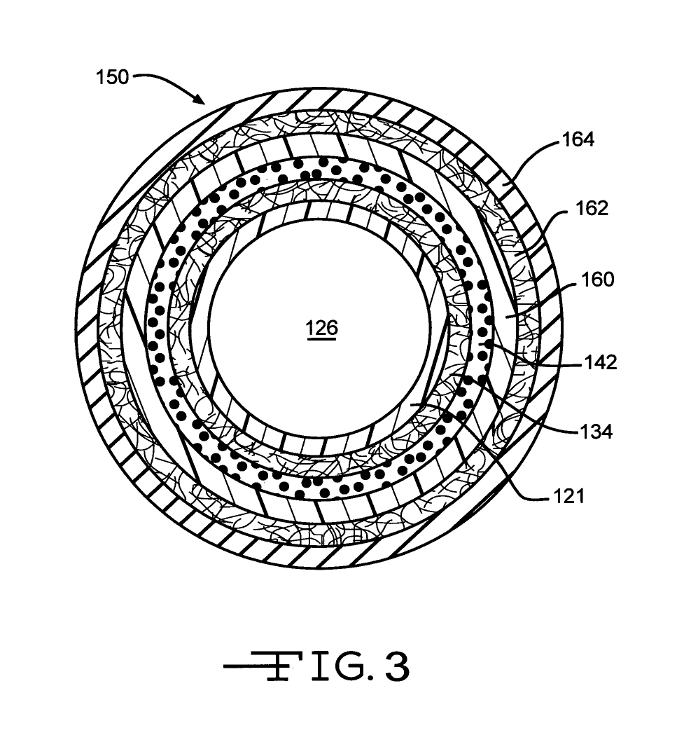

Referring again to FIG. 1, an inner liner ribbon 20 is rotationally applied to the tape layer 19 by a first extruder 22. As shown in FIG. 2, the inner liner ribbon 20 is configured to form an interior or inner passage 26 within the continuous pipe and simultaneously form an inner liner layer 21. The inner liner layer 21 is also configured to have an adhesive surface upon which various subsequent layers forming a continuous pipe can be applied.

The inner liner ribbon 20 is made of a resin-based material. Examples of resin-based inner liner ribbon 20 materials include polyvinyl chloride (PVC), polypropylene (PP) and polyethylene (PE), and combinations of these materials. However, other resin-based materials can be used. Optionally, the resin-based material for the inner liner ribbon 20 can be reinforced with chopped fibers, such as for example glass fibers.

The inner liner ribbon 20 has a width WIL and a thickness TIL. In the illustrated embodiment, the width WIL is in a range of from about 40.0 mm to about 400.0 mm and the thickness TIL is in a range of from about 0.5 mm to about 50.0 mm. Alternatively, the width WIL can be less than about 40.0 mm or more than about 400.0 mm and the thickness TIL can be less than about 0.5 mm or more than about 50.0 mm.

The inner liner ribbon 20 is applied to the tape layer 19 with the thermoplastic resin in a heated, semi-molten condition. The heated, semi-molten condition of the inner liner ribbon 20 is configured to facilitate adhesion to subsequent layers by providing a hot and sticky adhesive surface. In the illustrated embodiment, the inner liner ribbon 20 is heated to a temperature in a range of from about 130° C. to about 230° C. However, the inner liner ribbon 20 can be heated to temperatures less than about 130° C. or more than about 230° C.

Optionally, to maintain the inner liner layer 21 in a heated, semi-molten condition prior to the application of subsequent layers, a heater 24 can be directed to the inner liner layer 21. The heater 24 can be any desired structure, mechanism or device and can be configured to maintain inner liner layer 21 at any desired temperature. Optionally, the temperature of the inner liner layer 21 can be monitored by a sensor (not shown). The sensor can be any desired sensing mechanism or device.

The first extruder 22 is configured to provide the inner liner ribbon 20 in a continuous wrapped manner. The first extruder 22 can be any desired structure, mechanism or device sufficient and can include any desired structure or device, such as for example a flat die, to provide the inner liner ribbon 20. One example of a first extruder is an Alpa 45/60 single screw extruder provided by Cincinnati Extrusion GmbH headquartered in Vienna, Austria. However, other first extruders 22 can be used. The first extruder 22 is provided material for the inner liner ribbon 20 by a supply system (not shown). The supply system can be any desired structure or mechanism.

The inner liner ribbon 20 can be wrapped on the tape layer 19 in several manners. In the illustrated embodiment, the inner liner ribbon 20 is wrapped on the tape layer 19 in a manner such that successive applications of the inner liner ribbon 20 overlap previously installed applications of the inner liner ribbon 20. The overlap can be any desired amount. Alternatively, the inner liner ribbon 20 can be wrapped on the tape layer 19 in a manner such that an edge of successive applications of the inner liner ribbon 20 aligns with an edge of previously installed applications of the inner liner ribbon 20, resulting in no overlap of the wrapped inner liner ribbons 20.

Referring again to FIG. 1, after the inner liner ribbon 20 rotationally forms the inner liner layer 21, an intermediate ribbon 30 is rotationally applied to the inner liner layer 21 by an applicator 32. The intermediate ribbon 30 is configured to form an intermediate layer 34. Generally, as will be explained in more detail below, the intermediate layer 34 is configured to provide structural strength to the pipe while allowing a resulting relatively thin pipe wall thickness.

The intermediate ribbon 30 can be made of a resin-based commingled thermoplastic and glass fiber reinforcement material. One example of a resin-based commingled thermoplastic and glass fiber reinforcement material is Twintex® reinforcement material marketed by Owens Corning headquartered in Toledo, Ohio. An intermediate ribbon 30 made of the Twintex® reinforcement material provides longitudinally oriented thermoplastic fibers commingled with longitudinally oriented glass fibers. However, other resin-based commingled thermoplastic and fiber reinforcement materials can be formed into the intermediate ribbon 30. Non-limiting examples of other fiber reinforcement materials include aramid fibers, carbon fibers and metallic fibers.

The intermediate ribbon 30 has a width WIR and a thickness TIR. In the illustrated embodiment, the width WIR is in a range of from about 40.0 mm to about 400.0 mm and the thickness TIR is in a range of from about 0.3 mm to about 5.0 mm. Alternatively, the width WIR can be less than about 40.0 mm or more than about 400.0 mm and the thickness TIR can be less than about 0.3 mm or more than about 5.0 mm.

The intermediate ribbon 30 is applied to the inner liner layer 21 with the thermoplastic resin in a heated, semi-molten condition. The heated, semi-molten condition of the intermediate ribbon 30 is configured to facilitate adhesion to subsequent layers by providing a hot and sticky adhesive surface. In the illustrated embodiment, the intermediate ribbon 30 is heated to a temperature in a range of from about 130° C. to about 230° C. However, the intermediate ribbon 30 can be heated to temperatures less than about 130° C. or more than about 230° C.

Optionally, to maintain the intermediate layer 34 in a heated, semi-molten condition prior to the application of subsequent layers, a heater 37 can be directed to the intermediate layer 34. The heater 37 can be any desired structure, mechanism or device and can be configured to maintain intermediate layer 34 at any desired temperature. Optionally, the temperature of the intermediate layer 34 can be monitored by a sensor (not shown). The sensor can be any desired sensing mechanism or device.

The applicator 32 is configured to provide the intermediate ribbon 30 in a continuous wrapped manner. The applicator 32 can be any desired structure, mechanism or device or combination of structures, mechanisms or devices sufficient to provide the intermediate ribbon 30. The applicator 32 is provided material for the intermediate ribbon by a supply system (not shown). The supply system can be any desired structure or mechanism.

The intermediate ribbon 30 can be wrapped on the inner liner layer 21 in several manners. In the illustrated embodiment, the intermediate ribbon 30 is wrapped on the inner liner layer 21 in a manner such that successive applications of the intermediate ribbon 30 overlap previously installed applications of the intermediate ribbon 30. The overlap can be any desired amount. Alternatively, the intermediate ribbon 30 can be wrapped on the inner liner layer 21 in a manner such that an edge of successive applications of the intermediate ribbon 30 aligns with an edge of previously installed applications of the intermediate ribbon 30 resulting in no overlap of the wrapped intermediate ribbons 30.

The use of a resin-based commingled thermoplastic and glass fiber reinforcement material for the intermediate ribbon 30 advantageously allows the intermediate layer 34 to provide circumferential reinforcement to the continuous pipe 50. Additionally, as the intermediate ribbon 30 is applied on all portions of the continuous pipe 50, including irregular portions as will be discussed in detail below, the resin-based commingled thermoplastic and glass fiber reinforcement material provides structural support for all of the portions continuous pipe 50.

Optionally, the resin-based longitudinally oriented and commingled thermoplastic and glass fiber reinforcement material used for the intermediate ribbon 30 can be further reinforced by the introduction of a layer or layers of cross-directionally oriented reinforcement fibers (not shown) prior to or subsequent to the application of the intermediate ribbon 30 to the inner liner layer 21. The cross-directionally oriented reinforcement fibers can be oriented relative to the longitudinally oriented and commingled thermoplastic and glass fiber reinforcement material in any desired manner. In some embodiments, the cross-directionally oriented reinforcement fibers can have a generally aligned, closely spaced substantially parallel orientation. In other embodiments, the cross-directionally oriented reinforcement fibers can have a random orientation. The cross-directionally oriented reinforcement fibers can have any desired length. In some embodiments, the cross-directionally oriented reinforcement fibers can have a diameter in a range of from about 8 microns to about 30 microns and can be in a form of a strand that can have a weight within a range of from about 300 g/km to about 9600 g/km. Alternatively, the cross-directionally oriented reinforcement fibers can be in the form of a strand having a diameter less than about 8 microns or more than about 30 microns and a weight that is less than about 300 g/km or more than about 9600 g/km. The cross-directionally oriented reinforcement fibers can be made of any material sufficient for reinforcement purposes, such as for example glass fibers, mineral fibers and carbon fibers. The cross-directionally oriented reinforcement fibers can be a single filament or numerous filaments. The cross-directionally oriented reinforcement fibers can be introduced to the intermediate ribbon 30 in any desired manner including for example by nozzles using fluids to influence or control the orientation of the cross-directionally oriented reinforcement fibers. One example of a process for forming resin-based commingled thermoplastic and glass fiber reinforcement material having cross-directionally oriented reinforcement fibers is disclosed in PCT Publication number WO2008/027206, published Mar. 6, 2008, which is incorporated herein in its entirety.

In still further embodiments, the intermediate ribbon 30 can be formed from commingled resin-based thermoplastic and woven reinforcement fabrics. The woven reinforcement fabrics can be any desired woven reinforcement fabric suitable for commingling with resin-based thermoplastic and reinforcing the intermediate ribbon 30. One non-limiting example of a woven reinforcement fabric is woven Twintex® reinforcement material.

Referring again to FIG. 1, an outer ribbon 40 is rotationally applied to the intermediate layer 34 by a second extruder 44. The outer ribbon 40 is configured to form an outer layer 42. The outer layer 42 is configured to provide a protective layer for the continuous pipe.

The outer ribbon 40 is made of a resin-based material. Examples of resin-based outer ribbon 40 materials include polyvinyl chloride (PVC), polypropylene (PP) and polyethylene (PE) and combinations of these materials. However, other thermoplastic resin-based materials can be used. Optionally, the resin-based material for the outer ribbon 40 can be reinforced with chopped fibers, such as for example glass fibers.

The outer ribbon 40 has a width WO and a thickness TO. In the illustrated embodiment, the width WO is in a range of from about 40.0 mm to about 400.0 mm and the thickness TO is in a range of from about 0.5 mm to about 50.0 mm. Alternatively, the width WO can be less than about 40.0 mm or more than about 400.0 mm and the thickness TO can be less than about 0.5 mm or more than about 50.0 mm.

The second extruder 44 is configured to provide the outer ribbon 40 in a continuous manner. In one embodiment, the second extruder 44 is the same as or similar to the first extruder 22. However, the second extruder 44 can be other structures, mechanisms or devices sufficient to provide the outer ribbon 40 in a continuous manner. The second extruder 44 is provided material for the outer ribbon 40 by a supply system. The supply system can be any desired structure or mechanism.

The outer ribbon 40 can be wrapped on the intermediate layer 34 in the same manner as described above for the inner liner ribbon 20.

Referring again to FIG. 1, the inner liner layer 21, intermediate layer 34 and outer layer 42 form a continuous pipe 50. The continuous pipe 50 has an outer surface 51.

Optionally, a roller 52 can apply pressure and/or heat to the surface 51 of the continuous pipe 50. The roller 52 is configured to simultaneously smooth the outer surface 51 of the continuous pipe 50 and consolidate the inner liner layer 21, intermediate layer 34 and outer layer 42 together. The roller 52 can be configured to apply any desired amount of pressure and/or any amount of heat to the outer surface 51 of the continuous pipe 50. The roller 52 can be any desired structure, mechanism or device.

Optionally, a second cooling mechanism 53 can be configured to cool the continuous pipe 50. The second cooling mechanism 53 can be configured to cool the continuous pipe 50 to any desired temperature. The second cooling mechanism 53 can be any desired structure, mechanism or device, such as a blower.

As shown in FIG. 1, a cutter 54 is configured to cut the continuous pipe 50 into segments 56. In the illustrated embodiment, the cutter 54 is a circular saw that rotates around the exterior of the continuous pipe 50 on a guide system (not shown). The circular saw and the continuous pipe are configured to rotate at substantially the same rotational speed, thereby ensuring a clean and precise cut of the continuous pipe 50. However, the cutter 54 can be any desired structure, mechanism or device sufficient to cut the continuous pipe 50 into segments 56. The segments 56 can have any desired length.

Referring now to FIG. 2, a cross-section of the continuous pipe 50 is illustrated. The continuous pipe has the inner liner layer 21, intermediate layer 34 and outer layer 42.

The continuous pipe 50 has an outer diameter ODP. In the illustrated embodiment, the outer diameter ODP is in a range of from about 300 mm to about 3000 mm. In other embodiments, the outer diameter ODP can be less than about 300 mm or more than about 3000 mm.

The continuous pipe 50 has a wall thickness WT. In the illustrated embodiment, the wall thickness WT is in a range of from about 1.5 mm to about 55.0 mm. In other embodiments, the wall thickness WT can be less than about 1.5 mm or more than about 55.0 mm.

As discussed above, the passage 26 and inner liner layer 21 are configured for use with a variety of fluids. Non-limiting examples include drinking water, oil and sewage water.

The apparatus and methods discussed above can be used to manufacture continuous pipe having more than three layers. Referring now to FIG. 3, a continuous pipe 150 is illustrated. The continuous pipe 150 has an inner liner layer 121, a second layer 134, a third layer 142, a fourth layer 160, a fifth layer 162 and an outer layer 164.

Referring again to FIG. 3, the inner liner layer 121 and the fourth layer 160 are the same as or similar to the inner liner layer 21 illustrated in FIGS. 1 and 2 and described above. The inner liner layer 121 is configured to form inner passage 126. Similarly, the second layer 134 and the fifth layer 162 are the same as or similar to the intermediate layer 34 illustrated in FIGS. 1 and 2 and described above. The outer layer 164 is the same as or similar to the outer layer 42 illustrated in FIGS. 1 and 2 and described above.

The third layer 142 is a layer of foam-based material. The third layer is configured to increase the thickness wall of the continuous pipe 150 while having minimal weight impact. In the illustrated embodiment, the third layer is made of polyurethane foam. However, other foam-based materials, such as for example polyvinyl chloride (PVC) or polyethylene (PE) can be used. In the illustrated embodiment, the third layer 142 has a thickness in a range of from about 2.0 mm to about 50.0 mm. In other embodiments, the third layer 142 can have a thickness of less than about 2.0 mm or more than about 50.0 mm.

While the embodiment shown in FIG. 3 illustrates a quantity of six layers having the described application arrangement, it should be appreciated that other quantities of layers can be used in other arrangements.

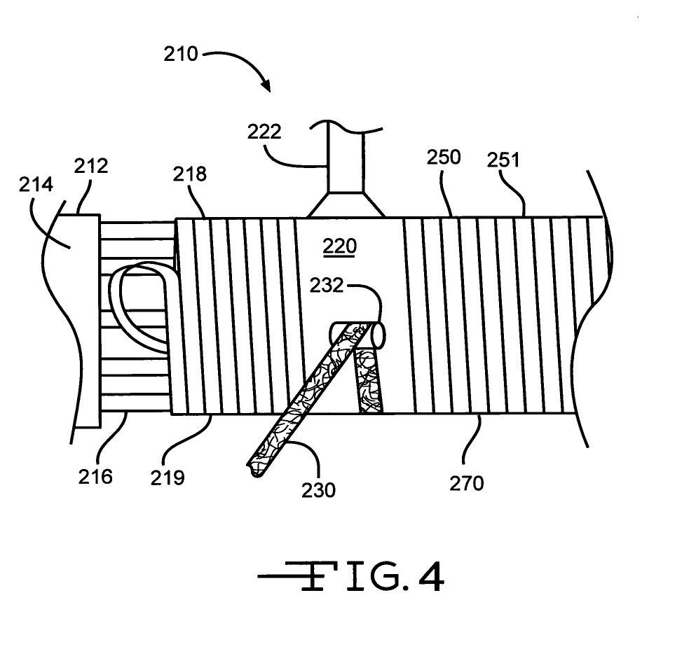

Another embodiment of an apparatus configured for manufacturing continuous pipe is illustrated, generally at 210, in FIG. 4. Generally, the apparatus 210 simultaneously applies an inner liner layer and a reinforcing layer to a rotating mandrel having a taped layer 219. Next, the inner liner layer and the reinforcing layer are overlapped in a manner such as to form an outer layer.

Referring now to FIG. 4, the apparatus 210 includes a mandrel 212 having a faceplate 214 and a plurality of rods 216. The rods 216 are covered by tape 218 forming tape layer 219. The mandrel 212, faceplate 214, rods 216, tape 218 and tape layer 219 are the same as or similar to the mandrel 12, faceplate 14, rods 16, tape 18 and tape layer 19 illustrated in FIG. 1 and described above.

Referring again to FIG. 4, an inner liner ribbon 220 is rotationally applied to the tape layer 219 by an extruder 222. The inner liner ribbon 220 and the extruder are the same as or similar to the inner liner ribbon 20 and the first extruder 22 illustrated in FIG. 1 and described above.

Referring again to FIG. 4, as the inner liner ribbon 220 is applied to the tape layer 219, a reinforcing layer 230 is applied to the inner liner ribbon 220 thereby forming continuous pipe 250. The reinforcing layer 230 is applied by an applicator 232. The reinforcing layer 230 and the applicator 232 are the same as or similar to the reinforcing ribbon 30 and the applicator 32 illustrated in FIG. 1 and described above. The reinforcing layer 230 is configured to adhere to the inner liner ribbon 220 thereby forming a composite ribbon 270. The resulting composite ribbon 270 overlaps previously applied composite ribbons 270 such that the reinforcing layers 230 of previously wrapped composite ribbons 270 are covered with successively wrapped composite ribbons 270. The wrapped composite ribbons 270 form outer surface 251.

The continuous pipe 250 can be heated, pressured, cooled and segmented as described above for continuous pipe 50.

Composite ribbons can be formed and wrapped in other manners. In one embodiment, a composite ribbon can be formed with integral resin, reinforcing and hollow portions. Referring now to FIG. 5, a composite ribbon 370 is illustrated. Generally, the composite ribbon 370 is configured for wrapping around a tape layer 319 in an overlapping manner thereby forming multiple layers, as shown in FIG. 7. The composite ribbon 370 includes resin portions, reinforced portions and hollow portions. The composite ribbon 370 includes a base 372, a top 374 and opposing sides 376a and 376b. The base 372 includes a base extension 378 and the top includes a top extension 379. The base 372, top 374 and opposing sides 376a and 376b cooperate to form a hollow core 380.

As shown in FIG. 5, the base 372 includes a reinforcing element 382. In some embodiments, the reinforcing element 382 can be resin-based commingled thermoplastic and fiber reinforcement materials, such as for example Twintex®, as discussed above. However, the reinforcing element 382 can be other desired reinforcing materials. In some embodiments, the base 372 can be the same as or similar to the intermediate ribbon 30 illustrated in FIG. 1 and described above. Similarly, the top 374 can be the same as or similar to the intermediate ribbon 30 illustrated in FIG. 1 and described above. In some embodiments, the opposing sides 376a and 386b can be the same as or similar to the inner liner ribbon 20 illustrated in FIG. 1 and described above.

In the illustrated embodiment, the hollow core 380 has a rectangular cross-sectional shape. Alternatively, the hollow core 380 can have other cross-sectional shapes. The hollow core 380, base 372 and top 374 form a composite ribbon thickness TCR. In the illustrated embodiment, the thickness TCR is in a range of from about 2.0 mm to about 50.0 mm. However, the thickness TCR can be other desired dimensions. The thickness TCR of the hollow core 380, base 372 and top 374 advantageously provide the continuous pipe with high rigidity, strength and stiffness at low weight. The apparatus and method of forming a continuous pipe with the composite ribbon 370 will be discussed in detail below.

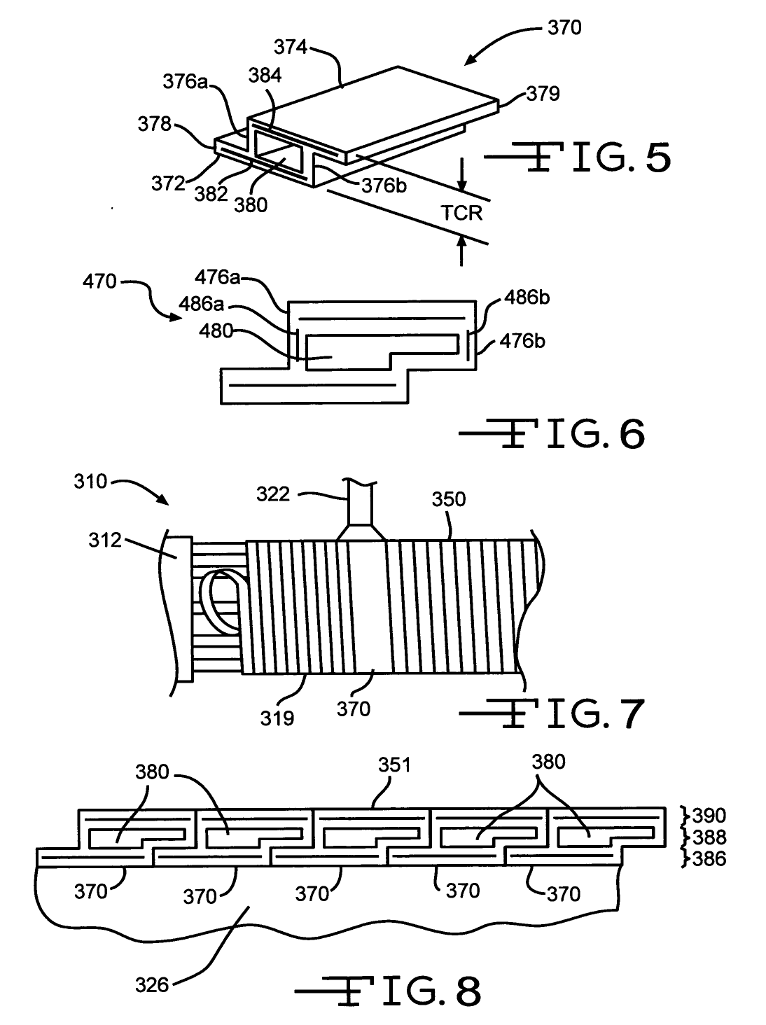

Referring now to FIG. 6, another embodiment of a composite ribbon 470 is illustrated. The composite ribbon 470 is the same as or similar to the composite ribbon 370 with the exceptions that the hollow core has a polygonal shape and the opposing sides 476a and 476b include reinforcing elements 486a and 486b. In the illustrated embodiment the opposing sides 476a and 476b can be the same as or similar to the intermediate ribbon 30 illustrated in FIG. 1 and described above.

Referring now to FIG. 7, the composite ribbon 370 can be formed into continuous pipe 350 using apparatus 310. Generally, the apparatus 310 applies the continuous ribbon 370 in a single overlapping layer to a rotating mandrel 312 having a tape layer 319. The mandrel 312 and the tape layer 319 are the same as or similar to the mandrel 12 and the tape layer 19 illustrated in FIG. 1 and described above.

As shown in FIG. 7, the composite ribbon 370 is rotationally applied to the tape layer 319 by an extruder 322. The extruder 322 is the same as or similar to the first extruder 22 illustrated in FIG. 1 and described above.

Referring again to FIG. 7, as the composite ribbon 370 is applied to the tape layer 319 by the extruder 322, the top extension 379 of the composite ribbon 370 seats against the base extension 378 of the base 372 of the previously applied composite ribbon 370. The overlapping of the composite ribbons 370 continues until the continuous pipe 350 is formed.

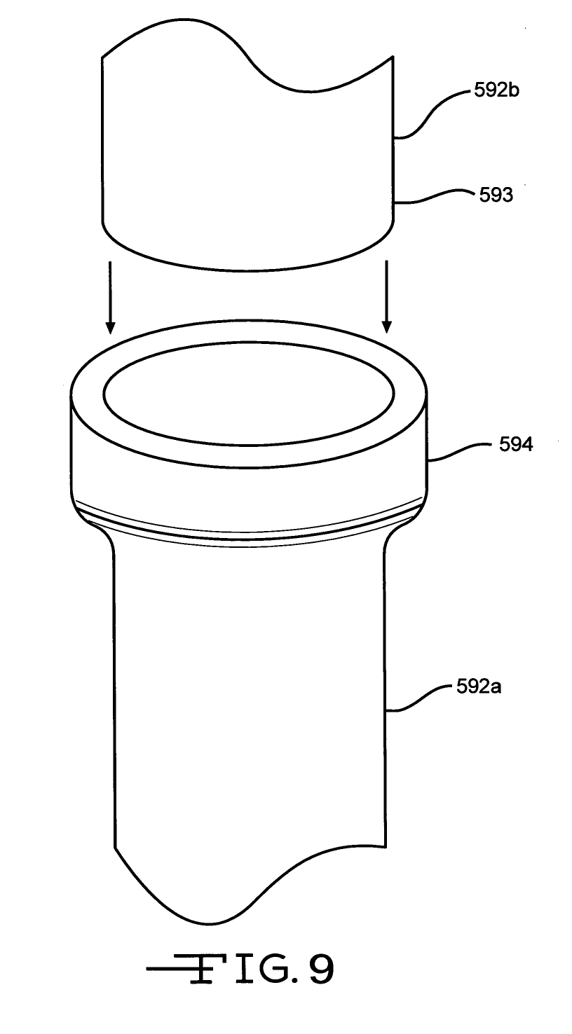

Referring now to FIG. 8, the overlapped composite ribbons 370 are illustrated. The overlapped composite ribbons 370 form a reinforced layer 386, an intermediate layer 388 and an outer layer 390. The reinforced layer 386 is configured to form an inner passage 326 similar to the inner passage 26 illustrated in FIG. 2. The intermediate layer 388 includes the hollow cores 380. The outer layer 390 is configured to form an outer surface 351 similar to the outer surface 51 illustrated in FIG. 1.

The apparatus and methods described above can be used to make continuous pipe having irregularly shaped portions. Referring now to FIG. 9, one example of an irregularly shaped portion is the bell housing 594 positioned at the end of the first pipe segment 592a. An end 593 of a second pipe segment 592b can be inserted into the bell housing 594, and the first and second pipe segments, 592a and 592b, can be joined by any desired method, such as for example by adhesives.

In certain embodiments, the bell housing 594 can include the layers illustrated in FIG. 2 or 3. Alternatively, the bell housing 594 can be formed from other layers.

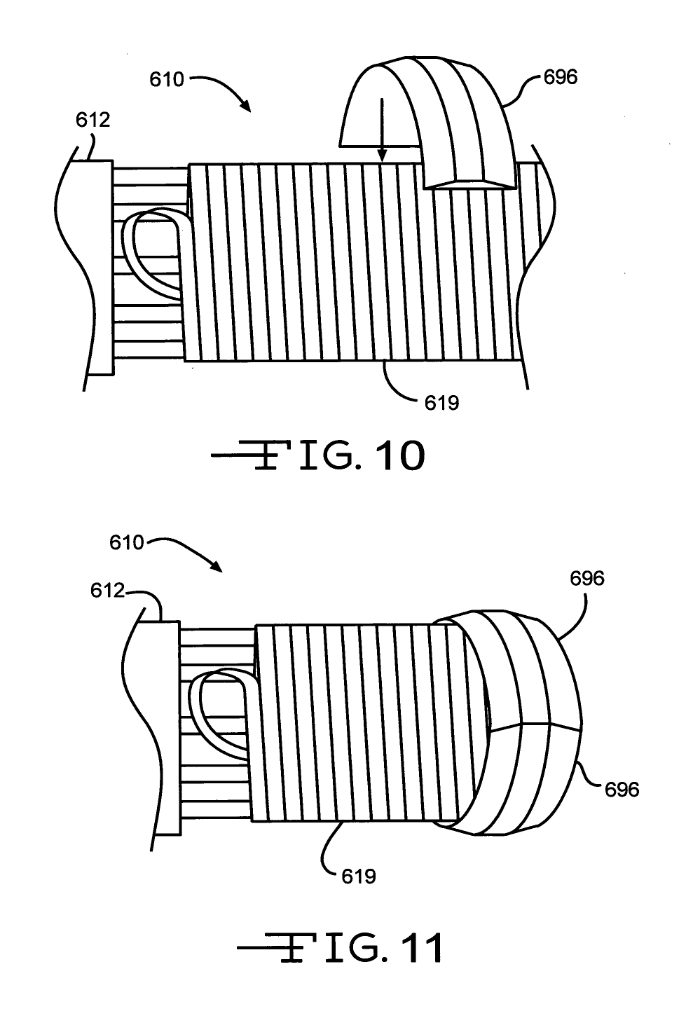

Referring now to FIGS. 10 and 11, the layers can be wrapped around a removable form 696. The removable form 696 is positioned around a tape layer 619 of a mandrel 612. Subsequent to the positioning of the removable form 696, the layers are wrapped around the tape layer 619 and the removable form 696 thereby forming the bell housing. After of the layers have been applied, the removable form 696 is removed leaving the shape of the bell housing. While the embodiment shown in FIGS. 10 and 11 illustrate the formation of a bell housing, it should be appreciated that other irregular shapes can be formed using the same process.

The principle and mode of operation of this invention have been described in certain embodiments. However, it should be noted that this invention may be practiced otherwise than as specifically illustrated and described without departing from its scope.

1. A method of manufacturing a continuous pipe from thermoplastic materials, including the steps of:
providing an endless mandrel having a releasable surface, the endless mandrel configured for rotation;
forming an inner liner layer on the releasable surface of the endless mandrel;
forming an intermediate layer on the inner liner layer;
forming an outer layer on the intermediate layer, thereby forming a continuous pipe; and
cutting the continuous pipe into segments;
characterized in that the inner liner layer is made of a thermoplastic material, the intermediate layer is made of commingled thermoplastic material and fiber reinforcement material, and the outer layer is made of a thermoplastic material.

2. The method of claim 1 wherein the thermoplastic material of the inner liner layer is polyvinyl chloride (PVC), polypropylene (PP) or polyethylene (PE), or combinations thereof.

3. The method of claim 1 wherein the inner liner layer has a width in a range of from about 40.0 mm to about 400.0 mm and a thickness in a range of from about 0.5 mm to about 50.0 mm.

4. The method of claim 1 wherein the fiber reinforcement material of the intermediate layer is glass.

5. The method of claim 1 wherein the intermediate layer has a width in a range of from about 40.0 mm to about 400.0 mm and a thickness in a range of from about 0.3 mm to about 5.0 mm.

6. The method of claim 1 wherein the intermediate layer having the commingled thermoplastic material and glass fiber reinforcement material is oriented circumferentially around the continuous pipe.

7. The method of claim 1 wherein the inner liner layer, the intermediate layer and the outer layer are formed by wrapping an inner liner ribbon, an intermediate ribbon and an outer ribbon on the endless mandrel in a heated condition thereby forming a hot and sticky surface facilitating adhesion with other wrapped ribbons.

8. The method of claim 7 wherein the inner liner ribbon, the intermediate ribbon and the outer ribbon are heated to a temperature in a range of from about 130° C. to about 230° C.

9. The method of claim 1 wherein the continuous pipe further includes a second intermediate layer.

10. The method of claim 9 wherein the second intermediate layer is made of polyurethane foam.

11. The method of claim 1 wherein the inner liner layer, intermediate layer and the outer layer form an irregular shape.

12. The method of claim 1 wherein the inner liner layer, intermediate layer and the outer layer form a composite ribbon having a hollow core.

13. The method of claim 12 wherein the hollow core has a rectangular cross-sectional shape.

14. The method of claim 12 wherein the inner liner layer and the outer layer include reinforcing elements.

15. The method of claim 12 wherein the composite ribbon includes a top extension and a base extension, and wherein the composite ribbons are applied to a tape layer in a manner such that the top extensions of successively installed composite ribbons overlap the base extensions of previously installed composite ribbons thereby forming the continuous pipe having a high rigidity, strength and stiffness at a low weight.
